(19) United States
(12) Patent Application Publication
(10) Pub. No.: US 2012/0135644 A1
(43) Pub. Date: May 31, 2012

(54) TERMINAL STRIP

(75) Inventor: Manfred Muller, Berlin (DE)

(73) Assignee: ADC GmbH, Berlin (DE)

(21) Appl. No.: 13/377,268

(22) PCT Filed: Mar. 26, 2010
(86) PCT No.: PCT/EP2010/001916

§ 371 Date: Feb. 6, 2012

(30) Foreign Application Priority Data
Jun. 9, 2009 (DE) 10 2009 024 330.5

(51) Int. Cl. H01R 24/28

(52) U.S. Cl. 439/660

(57) ABSTRACT

The invention relates to a terminal strip (1) for telecommunications and data technology, comprising a housing and wire connection contacts (50, 60), first wire connection contacts (50) being accessible from the upper side (19) of the housing and second wire connection contacts (60) being accessible from the upper side (19) or from the lower side (29) of the housing, and electrical interfaces being accessible from the upper side (19) of the housing, which interfaces (70, 74) are connected to the first and/or second wire connection contacts (50, 60), the housing having a housing upper part (10), a housing lower part (20) and a housing central part (30, 30′), the housing central part (30, 30′) having receptacles, in which the first and second wire connection contacts (50, 60) and the electrical interfaces (70, 74) are partially guided and mechanically supported.

The invention relates to a terminal strip for telecommunications and data technology.

Terminal strips for telecommunications and data technology are known in various embodiments, which have a housing and wire connection contacts. The housing is preferably made from plastic. The wire connection contacts are in this case usually in the form of insulation displacement contacts or in the form of wire-wrap contacts. In this case, first wire connection contacts are accessible from the upper side of the housing and are used, for example, for connecting incoming wires. Second wire connection contacts can likewise be accessible from the upper side or the lower side and are used for connecting outgoing wires. Furthermore, terminal strips with electrical interfaces are known which are in the form of isolating contacts or connection contacts, for example. Functional elements such as overvoltage protection elements or splitters can be connected between the first and second wire connection contacts (isolating contact) or connected thereto (for example connection contact for two-pole surge arrester) via these interfaces. Owing to the different design of the interfaces, the housing parts are not interchangeable, which makes manufacture of different terminal strips more difficult.

The invention is based on the technical problem of providing a terminal strip for telecommunications and data technology which can be matched in a less expensive manner to various electrical interfaces.

The solution to the technical problem results from the subject matter having the features of claim 1. Further advantageous configurations of the invention are given in the dependent claims.

In this regard, the terminal strip for telecommunications and data technology comprises a housing and wire connection contacts, first wire connection contacts being accessible from the upper side of the housing and second wire connection contacts being accessible from the upper side or from the lower side of the housing, and electrical interfaces being accessible from the upper side of the housing, which interfaces are connected to the first and/or second wire connection contacts, the housing having a housing upper part, a housing lower part and a housing central part, the housing central part having receptacles, in which the first and second wire connection contacts and electrical interfaces are partially guided and mechanically supported. This makes it possible to match a terminal strip in a simple manner to different electrical interfaces merely by matching the housing central part, but the housing upper part and the housing lower part thereof do not need to be altered. This correspondingly reduces the manufacturing costs. The receptacles are preferably formed by chambers which are formed between intermediate walls between a front and rear side wall.

In one embodiment, the housing central part is latched with the housing upper part and/or with the housing lower part.

In a further preferred embodiment, the electrical interfaces are in the form of connection contacts or in the form of isolating contacts.

In a further preferred embodiment, lugs, by means of which the terminal strip can be latched on a front panel and/or on an adapter, are arranged on the housing lower part. The terminal strip or a plurality of terminal strips can then be fastened on round rods or mounting troughs by means of the adapter.

The invention will be explained in more detail below with reference to a preferred exemplary embodiment. In the figures:

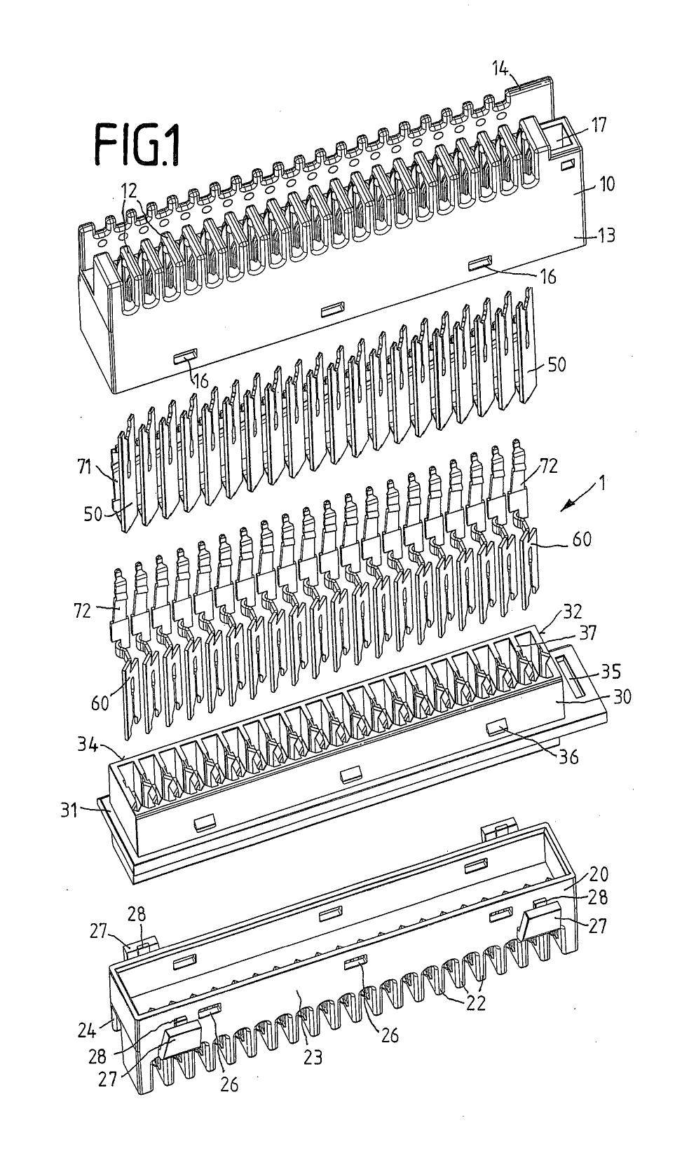

FIG. 1 shows an exploded illustration of a terminal strip with electrical interfaces in the form of isolating contacts,

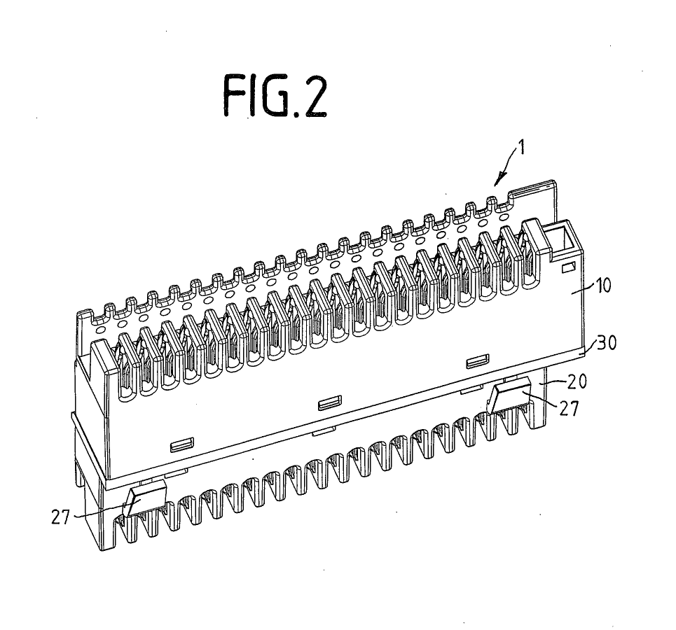

FIG. 2 shows a perspective illustration of an assembled terminal strip,

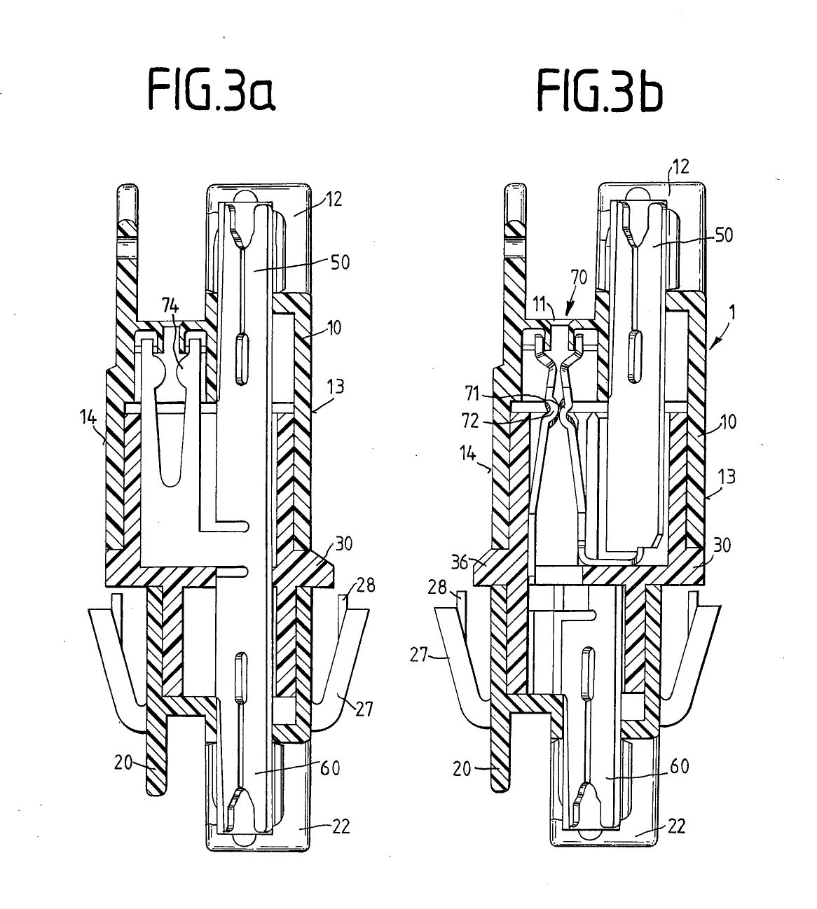

FIG. 3a shows a sectional illustration through a terminal strip with connection contacts as electrical interfaces,

FIG. 3b shows a sectional illustration through a terminal strip with isolating contacts as electrical interfaces,

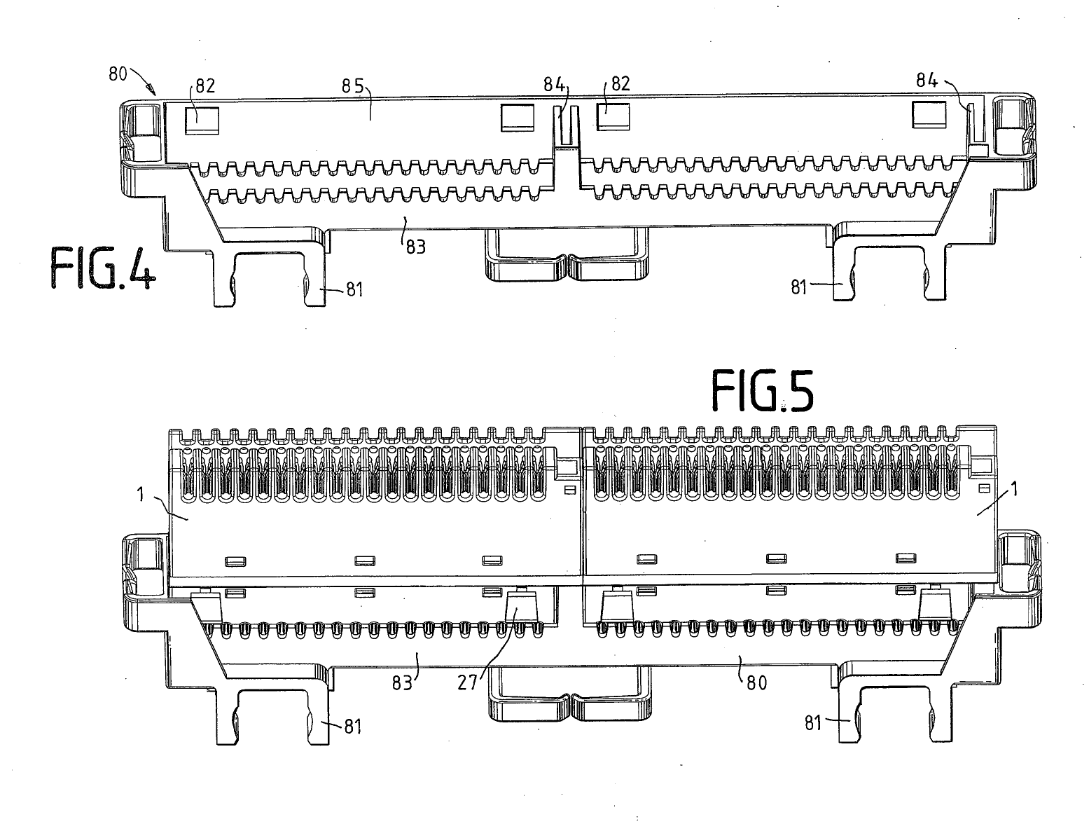

FIG. 4 shows a perspective illustration of an adapter for accommodating two terminal strips, and

FIG. 5 shows a perspective illustration of an adapter equipped with two terminal strips.

The terminal strip 1 comprises a housing upper part 10, a housing lower part 20 and a housing central part 30. Furthermore, the terminal strip 1 has first wire connection contacts 50, which are accessible from the upper side 19 of the housing, and second wire connection contacts 60, which are accessible from the lower side 29 of the housing. The first and second wire connection contacts 50, 60 are in this case in the form of insulation displacement contacts. In each case one contact limb 71, 72 is arranged at each first and second wire connection contact 50, 60. In each case one contact limb 71 of a first wire connection contact 50 and one contact limb 72 of a second wire connection contact 60 together form an isolating contact 70 (see FIG. 3b). The isolating contact 70 is in this case accessible from the upper side 19 of the housing. For this purpose, the housing upper part 10 has openings 11 above the isolating contacts 70. The housing upper part 10 has clamping webs 12, between which the wire connection contacts 50 are positioned. Furthermore, a front side wall 13 has three latching openings 16. Correspondingly, a rear side wall 14 also has such latching openings. The rear side wall 14 is raised up to the height of the front side wall 13, with the result that a channel 18, which is in the form of a U in cross section and on whose base the openings 11 for the isolating contacts 70 are positioned, is formed between the clamping webs 12 and the side wall 14 (see FIG. 3b).

The housing lower part 20, in a similar way to the housing upper part 10, has clamping ribs 22 and latching openings 26, but a rear side wall 24 is not raised up to the height of a front side wall 23. In each case two latching lugs 27 with a latching web 28 are arranged on the front and rear side walls 23, 24.

The housing central part 30 has, centrally, a peripheral rim 31, which is broader at a rear end side 32 of the housing central part 30 and has a slot 35, through which a grounding contact can be passed, for example. The slot 35 in this case corresponds to a parallelepipedal aperture 17 in the housing upper part 10. Furthermore, the housing central part 30 has six latching tabs 36 on a front side wall 33, three latching tabs 36 being arranged above the rim 31 and three latching tabs being arranged below the rim, with the lower latching tabs 36 being covered by the rim 31 in the illustration. Correspondingly, six latching tabs 36 are arranged on the rear side wall 34. The latching tabs 36 which are arranged above the rim 31 then, in the assembled state, latch into the latching openings 16 of the housing upper part 10, and the latching tabs 36 which are arranged below the rim 31 latch into the latching openings 26 of the housing lower part 20. Furthermore, the housing central part 30 has intermediate walls 37, which extend between the front and rear side walls 33, 34 and in the process form chambers 38, in which the wire connection contacts 50, 60, but also the electrical interfaces in the form of the isolating contacts 70 are partially guided. In this case, the formation of the chambers 38 and the intermediate walls 37 is dependent on the type of electrical interfaces.

The terminal strip 1 is matched to different electrical interfaces in this case exclusively by virtue of a matched housing central part 30′, whereas the housing upper part 10 and the housing lower part 20 remain unchanged. This becomes apparent on comparison of the illustrations in FIGS. 3a and 3b, with the electrical interface being in the form of a connection contact 74, which is integrally connected to the two wire connection contacts 50, 60, in FIG. 3a. The housing upper part 10 and the housing lower part 20 are of identical design, but the housing upper part 10 and the housing lower part 20 are positioned differently with respect to one another owing to the matched housing central part 30′. It should be noted here that the sections are positioned in such a way that the latching tabs 36 cannot be seen in FIGS. 3a and 3b.

The terminal strip 1 can latch behind a front panel by means of the latching lugs 27 with the latching web 28, the latching web 28 preventing the terminal strip from becoming unlatched if pressure is applied to said terminal strip 1.

FIG. 4 illustrates an adapter 80 which serves the purpose of fastening the terminal strips 1 on round rods. For this purpose, the adapter 80 is formed with two snap-action elements 81, which have radial notches. Furthermore, the adapter 80 has latching openings 82, into which the rearward latching lugs 27 of the terminal strip 1 latch. Two mounts 84 which are in the form of a U in cross section extend from a front side wall 83 in the direction of the rear side wall 85, the protruding part of the housing upper part 10 and the housing central part 30 resting on said mounts.

Finally, FIG. 5 illustrates the adapter 80 equipped with two terminal strips 1.

### LIST OF REFERENCE SYMBOLS

1 Terminal strip
10 Housing upper part
11 Openings
12 Clamping webs
13 Front side wall
14 Rear side wall
16 Latching openings
17 Parallelepipedal aperture
18 Channel
19 Upper side
20 Housing lower part
22 Clamping webs
23 Front side wall
24 Rear side wall
26 Latching openings
27 Latching lugs
28 Latching web
29 Lower side
30, 30′ Housing central part
31 Peripheral rim
32 Rear end side
33 Front side wall
34 Rear side wall
35 Slot
36 Latching tabs
37 Intermediate walls
38 Chamber
50 Wire connection contacts
60 Wire connection contacts
70 Isolating contact
71 Contact limb
72 Contact limb
74 Connection contact
80 Adapter
81 Snap-action elements
82 Latching openings
83 Front side wall
84 U-shaped mounts
85 Rear side wall

1. A terminal strip for telecommunications and data technology, comprising a housing and wire connection contacts, first wire connection contacts being accessible from the upper side of the housing and second wire connection contacts being accessible from the upper side or from the lower side of the housing, and electrical interfaces being accessible from the upper side of the housing, which interfaces are connected to the first and/or second wire connection contacts, wherein the housing has a housing upper part, a housing lower part and a housing central part, the housing central part having receptacles, in which the first and second wire connection contacts and the electrical interfaces are partially guided and mechanically supported.

2. The terminal strip as claimed in claim 1, wherein the housing central part is latched with the housing upper part and/or with the housing lower part.

3. The terminal strip as claimed in claim 1, wherein the electrical interfaces are in the form of connection contacts or in the form of isolating contacts.

4. The terminal strip as claimed in claim 1, wherein the terminal strip can be latched on a front panel and/or on an adapter the lugs arranged on the housing lower part.
